(19) United States
(12) Patent Application Publication
(10) Pub. No.: US 2025/0287128 A1
(43) Pub. Date: Sep. 11, 2025

(54) SPEAKER APPARATUS

(71) Applicant: SAMSUNG ELECTRONICS CO., LTD., Suwon-si (KR)

(72) Inventors: Jinseong KIM, Suwon-si (KR); Eunbi KANG, Suwon-si (KR); Sunggi KIM, Suwon-si (KR); Wonjun KIM, Suwon-si (KR); Seunghoon OH, Suwon-si (KR); Dongwon LEE, Suwon-si (KR)

(73) Assignee: SAMSUNG ELECTRONICS CO., LTD., Suwon-si (KR)

(21) Appl. No.: 19/217,323

(22) Filed: May 23, 2025

Related U.S. Application Data
(63) Continuation of application No. PCT/KR2023/017381, filed on Nov. 2, 2023.

(30) Foreign Application Priority Data
Jan. 3, 2023 (KR) 10-2023-0000939

(51) Int. Cl. H04R 1/02; F21V 33/00

(52) U.S. Cl. CPC H04R 1/026; F21V 33/0056

(57) ABSTRACT

An electronic apparatus may include a main housing configured to accommodate electronic components and including an elastic hole, and a sub-housing configured to be coupled to the main housing through the elastic hole. The main housing may include a deformation portion provided along one side of the elastic hole, a body portion provided along another side of the elastic hole, and a connection rib provided across the elastic hole to connect and support the deformation portion and the body portion. The sub-housing may include a hook inserted into the elastic hole to couple the sub-housing to the main housing, and during coupling of the sub-housing to the main housing, the deformation portion may undergo elastic deformation to enable the hook to be inserted into the elastic hole.

### CROSS-REFERENCE TO RELATED APPLICATION

This application is a bypass continuation application of International Patent Application No. PCT/KR2023/017381, filed on Nov. 2, 2023, which claims priority to Korean Patent Application No. 10-2023-0000939, filed on Jan. 3, 2023, in the Korean Intellectual Property Office, the disclosure of which are incorporated herein by reference in their entireties.

### BACKGROUND

Apparatuses and methods consistent with example embodiments relate to a speaker apparatus.

In general, a speaker is a device that generates sound by converting electrical signals into vibrations of a vibrating member.

A speaker may include a moving system, a suspension system, and a magnet system. The moving system may include components that are directly involved in sound reproduction, such as a diaphragm and a voice coil. The suspension system may include components, such as a damper and an edge, that support the outer and inner parts of the diaphragm in the correct position. The magnet system may refer to a system to optimize the movement of the diaphragm by allowing the magnetic field from the permanent magnets and the magnetic fields created by the voice coil to interact more efficiently.

Speakers may be categorized according to their shape as cone speakers, dome speakers, flat-panel speakers, ribbon speakers, horn speakers, and micro speakers.

As the shapes of speakers have become more diverse, the methods of designing the appearance of speakers have also become more diverse. In recent years, a design that installs a lamp inside the speaker and attaches a cover made of a light-transmissive material to some areas of the speaker's cover, allowing various colors of light generated by the lighting of the lamp to be transmitted to create an aesthetic effect, has become popular.

### SUMMARY

One or more embodiments of the present disclosure provides a speaker apparatus including a coupling structure capable of reducing the length of a hook.

One or more embodiments of the present disclosure provides a speaker apparatus including a coupling structure capable of preventing damage to a hook.

One or more embodiments of the present disclosure provides a speaker apparatus capable of efficiently utilizing internal space.

An aspect of the present disclosure provides an electronic apparatus may include a main housing configured to accommodate electronic components and including an elastic hole, and a sub-housing configured to be coupled to the main housing through the elastic hole. The main housing may include a deformation portion provided along one side of the elastic hole, a body portion provided along another side of the elastic hole, and a connection rib provided across the elastic hole to connect and support the deformation portion and the body portion. The sub-housing may include a hook inserted into the elastic hole to couple the sub-housing to the main housing, and during coupling of the sub-housing to the main housing, the deformation portion may undergo elastic deformation to enable the hook to be inserted into the elastic hole.

The elastic hole may include a first elastic hole and a second elastic hole separated by the connection rib, and the hook may include a first hook inserted into the first elastic hole and a second hook inserted into the second elastic hole.

The deformation portion may include a first deformation portion arranged to correspond to the first elastic hole and a second deformation portion arranged to correspond to the second elastic hole. The first deformation portion and the second deformation portion may be configured to elastically deform, respectively, during the coupling of the sub-housing to the main housing.

The sub-housing may include a guide rib configured to guide reception of the sub-housing into the elastic hole, and the guide rib may be configured to press the deformation portion of the main housing during the coupling of the sub-housing to the main housing.

The main housing may include a side wall protruding from the deformation portion to define one side of the elastic hole, and a guide rib groove provided in the side wall to allow the guide rib to be seated therein.

The main housing may include a hook fastening groove to which the hook is fastened, and the hook fastening groove may be at a position corresponding to the guide rib groove.

The guide rib may extend in a direction corresponding to a direction in which the hook extends from the sub-housing.

The elastic hole and the deformation portion may extend along a longitudinal direction of the main housing.

The connection rib may include a plurality of connection ribs provided along a direction in which the elastic hole extends, and the plurality of connection ribs may be spaced apart from each other to partition the elastic hole.

The sub-housing may be coupled to the main housing to cover the elastic hole.

A width of the deformation portion may be narrower than a width of the body portion.

The sub-housing may include a light-transmissive material.

The electronic apparatus may be a speaker apparatus.

A speaker apparatus according to one or more embodiments of the present disclosure includes a speaker. The speaker apparatus includes an electronic component arranged to be in contact with the speaker. The speaker apparatus includes a main housing accommodating the speaker and the electronic component and including an elastic hole. The speaker apparatus includes a sub-housing coupled to the main housing to cover the elastic hole. The main housing includes a deformation portion arranged along one side of the elastic hole. The main housing further includes a body portion arranged along the other side of the elastic hole. The sub-housing further includes a hook inserted into the elastic hole to support the sub-housing to the main housing. The sub-housing further includes a guide rib configured to press against the deformation portion of the main housing when the sub-housing is coupled to the main housing. The deformation portion elastically deforms when the sub-housing is coupled to the main housing, causing the hook to be inserted into the elastic hole.

The main housing may further include a connection rib arranged across the elastic hole to connect and support the deformation portion with the body portion.

The elastic hole may include a first elastic hole divided by the connection rib. The elastic hole may include a second elastic hole divided by the connection rib. The hook may include a first hook inserted into the first elastic hole. The hook may include a second hook inserted into the second elastic hole.

The deformation portion may include a first deformation portion arranged to correspond to the first elastic hole. The deformation portion may include a second deformation portion arranged to correspond to the second elastic hole. The first deformation portion and the second deformation portion may be configured to elastically deform, respectively, when the sub-housing is coupled to the main housing.

The main housing may further include a side wall protruding from the deformation portion to define one side of the elastic hole. The main housing may further include a guide rib groove formed in the side wall to allow the guide rib to be seated therein.

The main housing may further include a hook fastening groove to which the hook is fastened. The hook fastening groove may be formed at a position corresponding to the guide rib groove.

The elastic hole and the deformation portion may extend along a longitudinal direction of the main housing. The connection rib may include a plurality of connection ribs arranged along a direction in which the elastic hole extends. The plurality of connection ribs may be arranged to be spaced apart from each other to partition the elastic hole.

The speaker apparatus may further include a light emitting lamp configured to emit light in electrical contact with the electronic component. The sub-housing may include a light-transmissive material such that light emitted by the light emitting lamp is transmitted.

### BRIEF DESCRIPTION OF THE DRAWINGS

FIG. 1 is a view illustrating a speaker apparatus according to one or more embodiments.

FIG. 2 is a view illustrating the speaker apparatus of FIG. 1 from the rear.

FIG. 3 is an exploded view illustrating the speaker apparatus according to one or more embodiments.

FIG. 4 is a view illustrating an interior of the speaker apparatus according to one or more embodiments.

FIG. 5 is a view illustrating a state in which a sub-housing is fastened to a main housing according to one or more embodiments.

FIG. 6 is a view illustrating only the main housing and the sub-housing separated from the speaker apparatus according to one or more embodiments.

FIG. 7 is an enlarged view of area A of FIG. 6.

FIG. 8 is a side cross-sectional view after cutting the main housing and the sub-housing of FIG. 7 along the cutting surface a-a′.

FIG. 9 is a view illustrating a state in which the sub-housing is fastened to the main housing as a deformation portion of FIG. 8 elastically deforms.

FIG. 10 is a view illustrating a state in which the sub-housing is fastened to the main housing as a first deformation portion and a second deformation portion according to one or more embodiments are elastically deformed, respectively.

FIG. 11 is a view illustrating a state in which the sub-housing is fastened to the main housing according to one or more embodiments.

FIG. 12 is a view of FIG. 11 from another angle.

### DETAILED DESCRIPTION

Various embodiments of the present document and terms used therein are not intended to limit the technical features described in this document to specific embodiments, and should be understood to include various modifications, equivalents, or substitutes of the corresponding embodiments.

In addition, the same reference numerals or signs shown in the drawings of the disclosure indicate elements or components performing substantially the same function.

Also, the terms used herein are used to describe the embodiments and are not intended to limit and/or restrict the disclosure. The singular forms “a,” “an” and “the” are intended to include the plural forms as well, unless the context clearly indicates otherwise. In this disclosure, the terms “including”, “having”, and the like are used to specify features, figures, steps, operations, elements, components, or combinations thereof, but do not preclude the presence or addition of one or more of the features, figures, steps, operations, elements, components, or combinations thereof.

It will be understood that, although the terms “first”, “second”, “primary”, “secondary”, etc., may be used herein to describe various elements, but elements are not limited by these terms. These terms are only used to distinguish one element from another element. For example, without departing from the scope of the disclosure, a first element may be termed as a second element, and a second element may be termed as a first element. The term of “and/or” includes a plurality of combinations of relevant items or any one item among a plurality of relevant items.

Further, as used in the disclosure, the terms “front”, “rear”, “top”, “bottom”, “side”, “left”, “right”, “upper”, “lower”, and the like are defined with reference to the drawings, and are not intended to limit the shape and position of any element.

When a given element is referred to as being “connected to”, “coupled to”, “supported by” or “in contact with” another element, it is to be understood that it may be directly or indirectly connected to, coupled to, supported by, or in contact with the other element. When a given element is indirectly connected to, coupled to, supported by, or in contact with another element, it is to be understood that it may be connected to, coupled to, supported by, or in contact with the other element through a third element.

It will also be understood that when an element is referred to as being “on” another element, it may be directly on the other element or intervening elements may also be present.

In referring to the direction of rotation, a clockwise direction may be referred to as a first direction and a counterclockwise direction, which is the opposite of the first direction, as a second direction. Such representations may be used in describing specific details for implementing the disclosure, but the direction of rotation of the elements of the disclosure is not limited by these terms.

One or more embodiments of the present disclosure provide a coupling structure that may be universally applicable to assemble decorative components along the edges of a product (e.g., a main housing of an electronic apparatus such as a speaker). Elastic deformation of a mating component (e.g., the main housing) may be used to achieve secure engagement. The coupling structure may be applicable at peripheral or border regions of the main housing, where both space constraints and aesthetic considerations are critical.

According to various embodiments of the present disclosure, the main housing may undergo elastic deformation to engage with the sub-housing, thereby eliminating the need for the hook on the sub-housing to include additional length for its own elastic deformation.

According to various embodiments of the present disclosure, the hook may remain rigid without elastic deformation, thereby preventing potential breakage of the hook during assembly. By shifting the elastic deformation requirement to the main housing, the hook does not need to be thin or highly flexible. This may result in greater mechanical strength and reduces the risk of hook fracture or failure, even under repeated use.

As the hook may not require additional length for elastic deformation, the internal space within the speaker apparatus may be utilized more efficiently, corresponding to the reduced hook length. Compared to conventional hook-type designs, embodiments of the present disclosure may achieve the same or better coupling performance with a height reduction of at least 5.0 mm, enabling use in thin or tightly packaged assemblies without spatial limitations.

Hereinafter, various embodiments according to the disclosure will be described in detail with reference to the accompanying drawings.

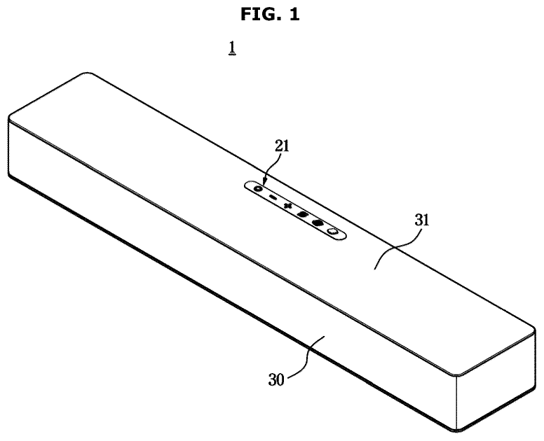

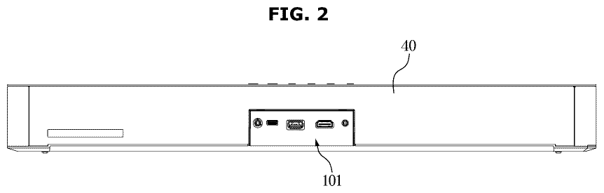

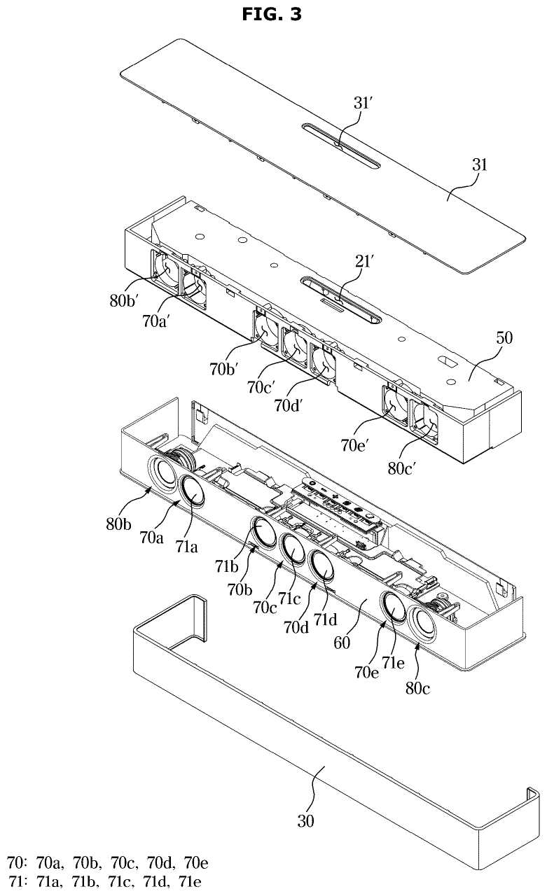

FIG. 1 is a view illustrating a speaker apparatus according to one or more embodiments. FIG. 2 is a view illustrating the speaker apparatus of FIG. 1 from the rear. FIG. 3 is an exploded view illustrating the speaker apparatus according to one or more embodiments.

Referring to FIGS. 1 to 3, a speaker apparatus 1 may include a main speaker 70. The main speaker 70 is a device that generates sound by converting electrical signals into vibrations of a vibration plate 71 (e.g., a diaphragm). The main speaker 70 may be provided in a plurality, and may be arranged symmetrically with respect to each other. More particularly, the main speakers 70 may be arranged in planar symmetry with respect to each other based on the center of an inner housing 50. The main speaker apparatus 1 may be formed in a bar-type shape. However, the position in which the main speaker 70 is arranged and the shape of the speaker apparatus 1 are not limited thereto.

The main speaker 70 is configured to include a magnetic circuitry and a vibration system.

The magnetic circuitry may be a portion to which an electrical signal is transmitted to generate sound in the main speaker 70. The magnetic circuitry is configured to include a magnet and a pole piece disposed in the center of the magnet.

The vibration system may be a portion in which sound is generated and output as vibration, and be configured to include a voice coil arranged in a gap formed between the magnet and the pole piece, a bobbin on which the voice coil is installed, and the vibration plate 71 movably arranged by a magnetic circuit in which the magnetic circuitry is formed.

With such a structure, the main speaker 70 may convert electrical signals into vibrations of the vibration plate 71, and may generate sound by generating compressional waves in the air through the vibrations. The operating principle of the main speaker 70 described above may be equally applied to the operation of front speakers 80b and 80c, which will be described below.

The speaker apparatus 1 may include the inner housing 50 on which components of the speaker apparatus 1, such as the speaker 70 are mounted, and a plurality of covers 30 and 40 configured to cover the inner housing 50. Components of the speaker apparatus 1 may be arranged and mounted on the inner housing 50. The inner housing 50 will be described in more detail later.

The plurality of covers 30 and 40 may be arranged to cover the inner housing 50, and may be configured to protect the components of the speaker apparatus 1 that are mounted within the inner housing 50. The plurality of covers 30 and 40 will be described in more detail later.

The speaker apparatus 1 may include an upper cover 31 configured to cover the inner housing 50. The upper cover 31 may be mounted on an upper portion of the inner housing 50. The upper cover 31 may include a grid pattern. Thereby, the aesthetics of the speaker apparatus 1 may be improved.

The speaker apparatus 1 may include a rear cover 40 configured to cover the inner housing 50. The rear cover 40 may be mounted on a rear side of the inner housing 50 to protect the components that are disposed within the inner housing 50.

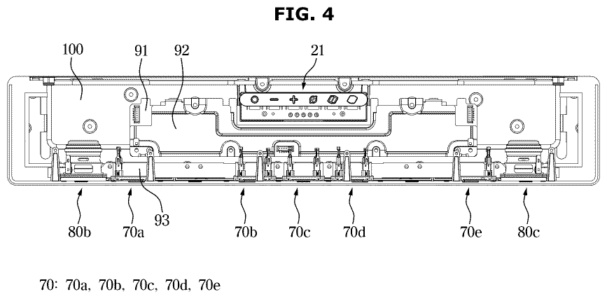

The speaker apparatus 1 may include a main housing 100 (see FIG. 4). The main housing 100 may be arranged on a lower portion of the inner housing 50 to cover the inner housing 50. The inner housing 50 may be arranged to be seated on the main housing 100. In other words, the main housing 100 may be configured to accommodate internal components (e.g., a processor, diaphragms, circuits etc.) of the speaker apparatus 1, such as the speaker 70, by covering the inner housing 50 as a lower cover.

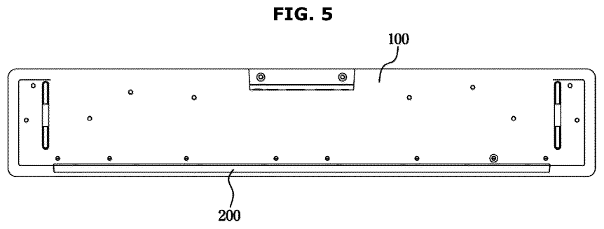

The speaker apparatus 1 may include a sub-housing 200 (see FIG. 5). The sub-housing 200 may be configured to be coupled with the main housing 100. A detailed description of the coupling between the sub-housing 200 and the main housing 100 will be described later.

The speaker apparatus 1 may include a connection hole 101 (see FIG. 2) through which wires from other external home appliances or an external power source for power supply may be physically connected. More particularly, the connection hole 101 may be provided on the rear cover 40 of the main housing 100. Through the connection hole 101, the speaker apparatus 1 may be connected to the outside and receive electrical signals to generate sound. However, the speaker apparatus 1 is not limited to such a method, and may be wirelessly connected to other home appliances via a wireless communication method to transmit and receive signals.

The speaker apparatus 1 may include a plurality of main speakers 70a, 70b, 70c, 70d and 70e. The main speakers 70a, 70b, 70c, 70d and 70e may be categorized as a cone speaker, a dome speaker, a flat panel speaker, a ribbon speaker, a horn speaker, and a micro speaker depending on the shape of the vibration plate 71a, 71b, 71c, 71d and 71e.

The cone speaker may have a cone-shaped vibration plate, which has generally flat frequency characteristic and allows sound in the low-frequency range to spread across the entire 360-degree direction.

The dome speaker may be a speaker with a dome-shaped vibration plate, and may be characterized in that the reproduction range is wide and spread evenly.

The flat panel speaker may refer to a speaker with a flat vibration plate without curvature, so that there is no time difference in the arrival of the sound generated from a plurality of speakers. The generated sound may have the characteristics of a spherical wave and a plane wave rather than a pure spherical wave, which may be characterized in that the sound may be sent far away.

The ribbon speaker may be a speaker with a ribbon-like shape, which has the characteristic that the driving force for moving the vibration plate is not generated from the voice coil, but is directly generated from the vibration plate itself.

The horn speaker may be a speaker having a horn-like shape, and may have a characteristic of concentrating sound in one direction.

The micro speaker may refer to a speaker with a size of 40-50 mm or less, and may be used mainly for small-sized products.

The plurality of main speakers 70a, 70b, 70c, 70d and 70e may be used as flat panel speakers, but are not limited thereto.

The description of the types of speakers mentioned above may be equally applied to the front speakers 80b and 80c.

The main speakers 70a, 70b, 70c, 70d and 70e may be arranged on side walls of the inner housing 50 and function as side speakers.

The main speakers 70a, 70b, 70c, 70d and 70eeach installed on the side walls of the inner housing 50 may be configured to generate sound in a left-and-right direction of the speaker apparatus 1.

The speaker may include a plurality of front speakers 80b and 80c mounted on a front wall 60 of the inner housing 50. The front speakers 80b and 80c may be configured as two front speakers. The front speakers 80b and 80c may include a first front speaker 80b arranged on a right side of the front wall 60, and a second front speaker 80c arranged on a left side of the front wall 60.

The first front speaker 80b may generate sound toward a front right side of the inner housing 50, and the second front speaker 80c may generate sound toward a front left side of the inner housing 50. However, the shape, position, and number of the front speakers 80b and 80c are not limited thereto.

The plurality of front speakers 80b and 80c may be mounted on the inner housing 50, respectively. More particularly, the front wall 60 of the inner housing 50 may include front speaker holes 80b′ and 80c′ arranged corresponding to the plurality of front speakers 80b and 80c for mounting the plurality of front speakers 80b and 80c. The plurality of front speakers 80b and 80c may be mounted on the inner housing 50 by being inserted into the front speaker holes 80b′ and 80c′, respectively.

The plurality of main speakers 70a, 70b, 70c, 70d and 70e may be mounted on the front wall 60 of the inner housing 50. Five main speakers 70a, 70b, 70c, 70d and 70e may be provided. The plurality of main speakers 70a, 70b, 70c, 70d and 70e may include a first main speaker 70a and a second main speaker 70b arranged on the right side of the front wall 60. The plurality of main speakers 70a, 70b, 70c, 70d and 70e may include a fourth main speaker 70d and a fifth main speaker 70e arranged on the left side of the front wall 60. The plurality of main speakers 70a, 70b, 70c, 70d and 70e may include a third main speaker 70c arranged at the center of the front wall 60. However, the shape, position, and number of the main speakers 70 are not limited thereto and may be provided in various ways.

The front wall 60 of the inner housing 50 may be provided with main speaker holes 70a′, 70b′, 70c′, 70d′ and 70e′ for mounting the plurality of main speakers 70a, 70b, 70c, 70d and 70e. The plurality of main speakers 70a, 70b, 70c, 70d and 70e may be mounted on the inner housing 50 by being inserted into the main speaker holes 70a′, 70b′, 70c′, 70d′ and 70e′, respectively.

The speaker apparatus 1 may include a plurality of woofers. The woofers may be components for generating low-frequency sounds of 3,000 Hz or less in the audible frequency range. The woofers may be included in the speaker apparatus 1 to improve consumer satisfaction by generating sound with a range of different frequencies.

The woofers may be installed along the front wall 60 of the inner housing 50. The woofers may be installed along the main housing 100. However, the installation position of the woofers mentioned above is merely by way of examples, and it should be understood that the woofers may be arranged at various positions on the speaker 1.

The inner housing 50 may include woofer holes on which the woofers may be mounted. The woofers may be mounted on the inner housing 50 by being inserted into the woofer holes, respectively.

Meanwhile, the arrangement and number of the plurality of main speakers 70, the front speakers 80b and 80c, and the woofers, as well as the main speaker holes 70a, 70b, 70c, 70d and 70e, the front speaker holes 80b′, 80c′, and the woofer holes for accommodating them, are merely by way of examples, and may be provided in various ways, as needed.

The front cover 30 may be attached to a front surface of the inner housing 50. The front cover 30 may be coupled to the front wall 60 to protect the front speakers 80b and 80c, the main speakers 70, and the plurality of woofers arranged on the front wall 60. The front cover 30 may be provided in the shape of a grille. According to such a shape, the front cover 30 may prevent the front speakers 80b and 80c, the main speakers 70a, 70b, 70c, 70d and 70e, and the woofers from being pressed by pointed members, and may also have an aesthetic effect.

The speaker apparatus 1 may include an operating portion 21. The operating portion 21 may be provided with an on/off button and a volume control button for the speaker apparatus 1 and allow a user to easily control the speaker apparatus 1.

The operating portion 21 may be arranged to be installable on the inner housing 50. The inner housing 50 may include an inner housing hole 21′ in which the operating portion 21 is installed. The operating portion 21 may be arranged to be inserted into the inner housing hole 21′.

The upper cover 31 may include an upper cover hole 31′ that allows the operating portion 21 installed in the inner housing 50 to be exposed to the outside. The upper cover hole 31′ may be configured to pass through the upper cover 31. The upper cover hole 31′ may be provided in the same shape as the operating portion 21.

FIG. 4 is a view illustrating an interior of the speaker apparatus according to one or more embodiments. FIG. 5 is a view illustrating a state in which the sub-housing is fastened to the main housing according to one or more embodiments.

Referring to FIGS. 4 to 5, the speaker apparatus 1 may include an electronic component 91 arranged therein. More particularly, the electronic component 91 may be arranged to be seated on the main housing 100. The electronic component 91 may be provided as a printed board assembly (PBA) or the like connected to the plurality of front speakers 80b and 80c, the main speakers 70, and the woofers.

The electronic component 91 may include a printed circuit board (PCB). The PCB may be provided as a board, such as a substrate, on which conductive circuitry is formed on or within an insulating base for electrically connecting components. The PCB may be configured to electrically contact the components of the speaker apparatus 1 described above to control the components thereof.

The speaker apparatus 1 may include an electronic component cover 92. The electronic component cover 92 may be arranged to be disposed between the inner housing 50 and the electronic component 91. The electronic component cover 92 may be configured to cover the electronic component 91 to protect the electronic component 91.

The speaker apparatus 1 may include a light emitting lamp board 93. The light emitting lamp board 93 may be in electrical contact with the electronic component 91. The electronic component 91 may control a light emitting lamp on the light emitting lamp board 93 to emit light.

The light emitting lamp board 93 may be disposed adjacent to the sub-housing 200. The light emitting lamp board 93 may be provided in a shape corresponding to the sub-housing 200. The sub-housing 200 may include a light-transmissive material through which light is transmitted. Thus, the light emitted by the light emitting lamp may be emitted to the outside through the sub-housing 200, and an aesthetic effect due to light may be generated when the speaker apparatus 1 is operated.

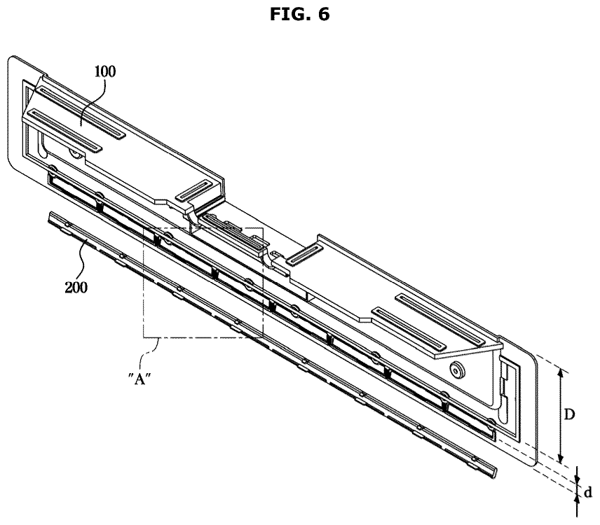

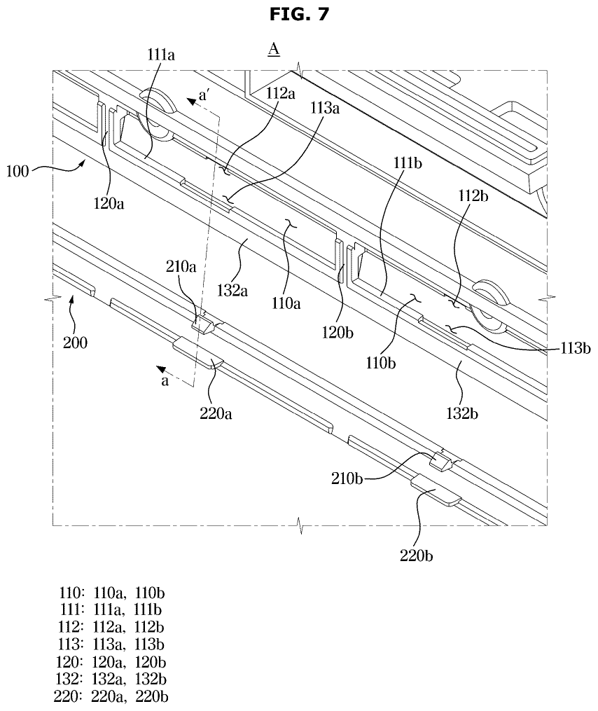

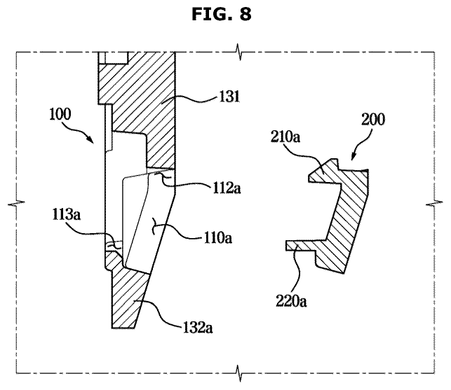

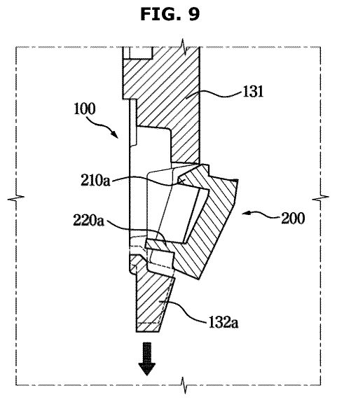

FIG. 6 is a view illustrating only the main housing and the sub-housing separated from the speaker apparatus 1 according to one or more embodiments. FIG. 7 is an enlarged view illustrating area A of FIG. 6. FIG. 8 is a side cross-sectional view after cutting the main housing and the sub-housing of FIG. 7 along the cutting surface a-a′. FIG. 9 is a view illustrating a state in which the sub-housing is fastened to the main housing while a deformation portion of FIG. 8 elastically deforms.

Referring to FIGS. 6 to 9, the main housing 100 may include an elastic hole 110. The main housing 100 may include a deformation portion 132 arranged along one side of the elastic hole 110. The main housing 100 may include a body portion 131 arranged along the other side of the elastic hole 110. In other words, the elastic hole 110 may be formed with the deformation portion 132 on one side and the body portion 131 on the other side.

A width D of the deformation portion 132 may be formed narrower than a width d of the body portion 131. Accordingly, the deformation portion 132 may be configured to elastically deform in response to coupling of the sub-housing 200 to the main housing 100.

The sub-housing 200 may be accommodated in the elastic hole 110 and coupled to the main housing 100. The elastic hole 110 may be sized corresponding to the sub-housing 200 to accommodate the sub-housing 200. The elastic hole 110 may be configured to extend along a longitudinal direction of the main housing 100.

The main housing 100 may include a connection rib 120 arranged across the elastic hole 110 to connect and support the deformation portion 132 with the body portion 131. Accordingly, the elastic hole 110 may include a first elastic hole 110a and a second elastic hole 110b, which are divided by the connection rib 120.

The connection ribs 120 may be provided in a plurality. The plurality of connection ribs 120a and 120b may be arranged to be spaced apart from each other to divide the elastic holes 110a and 110b. The plurality of connection ribs 120a and 120b may be arranged to be equally spaced apart from each other. The plurality of connection ribs 120a and 120b may extend along a direction in which the elastic hole 110 extends. Here, the interval at which the plurality of connection ribs 120a and 120b are spaced apart from each other may be varied depending on the shape of the speaker apparatus 1.

The deformation portion 132 may be elastically deformable to move the sub-housing 200 away from the body portion 131 when the sub-housing 200 is coupled to the main housing 100. The deformation portion 132 may be elastically deformed based on the point where the deformation portion 132 is supported in contact with the connection rib 120. In other words, a portion of the deformation portion 132 that is in contact with the plurality of connection ribs 120a and 120b may not be elastically deformed when the sub-housing 200 is coupled to the main housing 100. Accordingly, the deformation portion 132 may include a first deformation portion 132a and a second deformation portion 132b, which are differentiated based on the point of contact with the connection rib 120b.

The first deformation portion 132a may be arranged to correspond to the first elastic hole 110a. The second deformation portion 132b may be arranged to correspond to the second elastic hole 110b. The first deformation portion 132a and the second deformation portion 132b may be elastically deformable, respectively, when the sub-housing 200 is coupled to the main housing 100.

The amount of elastic deformation of each of the deformation portions 132a and 132b may be controlled by a distance at which the plurality of connection ribs 120a and 120b are spaced apart from each other. In other words, since the portion of the deformation portion 132 that is in contact with the connection rib 120 does not deform when the main housing 100 and the sub-housing 200 are coupled, the shorter the distance at which the plurality of connection ribs 120 are spaced apart from each other, the less the amount of deformation of the elastic portion may be.

The sub-housing 200 may be coupled to the main housing 210 via a snap fit mechanism that employs a flexible feature to snap into place itself or allow a corresponding part to snap into engagement. The snap fit mechanism may include a protruding element, such as a hook, bead, or ridge, configured to engage with a corresponding hole, undercut, or groove in a mating part. In some embodiments, the protruding element (e.g., a hook 210) is positioned on the sub-housing 200, while an elastic hole 110 is formed in the main housing 210. However, the present disclosure is not limited to this configuration; alternatively, the protruding element may be located on the main housing 210, with the elastic hole 110 formed in the sub-housing 200. Additionally, in certain embodiments, the main housing 210 provides the flexible feature via the hole, although either or both of the main housing 210 and the sub-housing 200 may incorporate a flexible feature to implement the snap fit mechanism.

In one or more embodiments, the sub-housing 200 may include a hook 210 inserted into the elastic hole 110 to support the sub-housing 200 on the main housing 100. The sub-housing 200 may be coupled to the main housing 100 by hooking the hook 210 arranged in the sub-housing 200 to the main housing 100. More particularly, the main housing 100 may include a hook fastening groove 112. The hook 210 may be fastened into the hook fastening groove 112 of the main housing 100 to couple the sub-housing 200 to the main housing 100. The hook fastening groove 112 may include a plurality of hook fastening grooves 112a and 112b.

The hook 210 of the sub-housing 200 may be inserted into the elastic hole 110 of the main housing 100. When the hook 210 is inserted into the elastic hole 110 and the sub-housing 200 is coupled to the main housing 100, the deformation portion 132 may be elastically deformed.

Since the hook 210 does not elastically deform when the main housing 100 and the sub-housing 200 are coupled, the hook 210 may not include a length for elastically deforming. Since the hook 210 does not elastically deform, damage to the hook 210 may be prevented. Furthermore, since the hook 210 does not need to include a length for elastic deformation, an internal space of the speaker apparatus 1 may be utilized to the extent of the shortened length. In other words, a space for positioning the light emitting lamp board 93, which is disposed adjacent to the sub-housing 200, may be secured.

A plurality of hooks 210a, 210b of the sub-housing 200 may be provided. The plurality of hooks 210a, 210b may include a first hook 210a inserted into the first elastic hole 110a. The plurality of hooks 210a, 210b may include a second hook 210b inserted into the second elastic hole 110b.

The sub-housing 200 may further include a guide rib 220 that guides the sub-housing 200 being received in the elastic hole 110. The guide rib 220 may be formed in the sub-housing 200 at a position corresponding to a point where the hook 210 is positioned. The guide rib 220 may extend in a direction corresponding to the direction in which the hook 210 extends from the sub-housing 200. The guide rib 220 may include a plurality of guide ribs 220a, 220b.

The main housing 100 may include a side wall 111 protruding from the deformation portion 132 so as to define one side of the elastic hole 110.

The side wall 111 may be configured to protrude from the deformation portion 132 toward the body portion 131. The side wall 111 formed on the deformation portion 132 may be configured to protrude from the connection rib 120. The side wall 111 may include a plurality of side walls 111a, 111b.

The main housing 100 may include a guide rib groove 113. More particularly, the guide rib groove 113 may be formed in the side wall 111. When the guide rib 220 is inserted into the elastic hole 110, the guide rib 220 may be configured to be seated in the guide rib groove 113. The guide rib groove 113 may include guide rib grooves 113a, 113b.

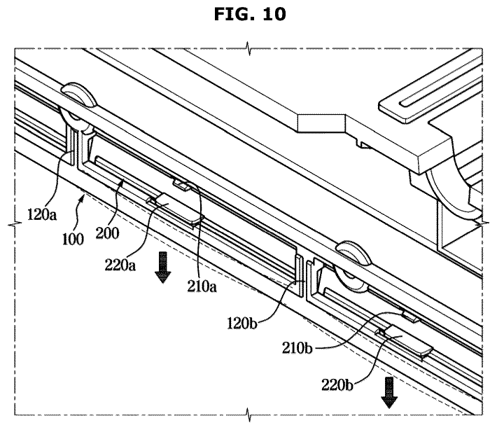

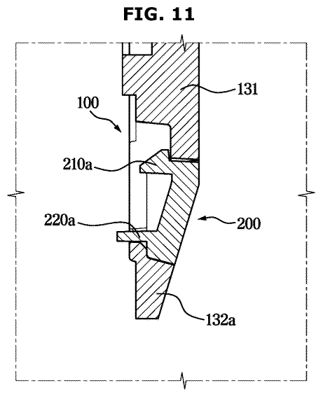

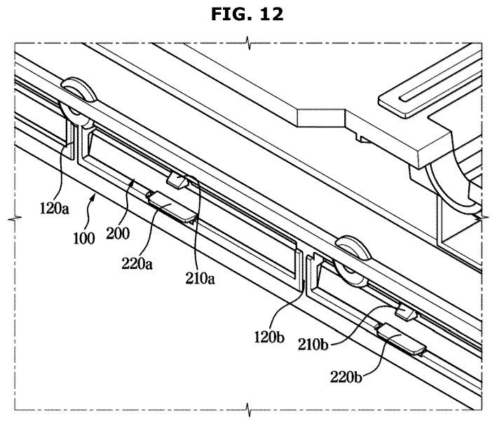

FIG. 10 is a view illustrating a state in which the sub-housing is fastened to the main housing while a first deformation portion and a second deformation portion according to one or more embodiments are elastically deformed, respectively. FIG. 11 is a view illustrating a state in which the sub-housing is fastened to the main housing according to one or more embodiments. FIG. 12 is a view illustrating FIG. 11 from another angle.

Referring to FIGS. 10 to 12, the sub-housing 200 may be coupled to cover the main housing 100. The detailed process by which the sub-housing 200 is coupled to the main housing 100 will be described below.

The guide rib 220 of the sub-housing 200 may be inserted into the elastic hole 110. The guide rib 220 inserted into the elastic hole 110 may be seated in the guide rib groove 113 arranged in the deformation portion 132 of the main housing 100. Thereafter, when the hook 210 is inserted into the elastic hole 110, the guide rib 220 may press against the guide rib groove 113. As the guide rib groove 113 is pressed, the deformation portion 132 of the main housing 100 may be pressed.

In response to the guide rib 220 pressing the deformation portion 132, the deformation portion 132 may elastically deform in the direction away from the body portion 131. As the deformation portion 132 elastically deforms, the size of the elastic hole 110 may increase. As the size of the elastic hole 110 increases, the hook 210 may be inserted into the elastic hole 110. The hook 210 inserted into the elastic hole 110 may be seated in the hook fastening groove 112 of the body portion 131. After the hook 210 is seated in the hook fastening groove 112, the deformation portion 132 may be elastically deformed in the direction closer to the body portion 131. As a result, the sub-housing 200 may be coupled to the main housing 100 to cover the elastic hole 110 of the main housing 100.

While the present disclosure has been particularly described with reference to exemplary embodiments, it should be understood by those of skilled in the art that various changes in form and details may be made without departing from the spirit and scope of the present disclosure.

What is claimed is:

1. An electronic apparatus comprising:
a main housing configured to accommodate electronic components and comprising an elastic hole; and
a sub-housing configured to be coupled to the main housing through the elastic hole;
wherein the main housing comprises:
a deformation portion provided along one side of the elastic hole,
a body portion provided along another side of the elastic hole, and
a connection rib provided across the elastic hole to connect and support the deformation portion and the body portion,
wherein the sub-housing comprises a hook inserted into the elastic hole to couple the sub-housing to the main housing, and
during coupling of the sub-housing to the main housing, the deformation portion undergoes elastic deformation to enable the hook to be inserted into the elastic hole.

2. The electronic apparatus of claim 1, wherein
the elastic hole comprises a first elastic hole and a second elastic hole separated by the connection rib, and
the hook comprises a first hook inserted into the first elastic hole and a second hook inserted into the second elastic hole.

3. The electronic apparatus of claim 2, wherein
the deformation portion comprises a first deformation portion arranged to correspond to the first elastic hole and a second deformation portion arranged to correspond to the second elastic hole, and
the first deformation portion and the second deformation portion are configured to elastically deform, respectively, during the coupling of the sub-housing to the main housing.

4. The electronic apparatus of claim 1, wherein
the sub-housing further comprises a guide rib configured to guide reception of the sub-housing into the elastic hole, and
the guide rib is configured to press the deformation portion of the main housing during the coupling of the sub-housing to the main housing.

5. The electronic apparatus of claim 4, wherein the main housing further comprises a side wall protruding from the deformation portion to define one side of the elastic hole, and a guide rib groove provided in the side wall to allow the guide rib to be seated therein.

6. The electronic apparatus of claim 5, wherein
the main housing further comprises a hook fastening groove to which the hook is fastened, and
the hook fastening groove is at a position corresponding to the guide rib groove.

7. The electronic apparatus of claim 4, wherein the guide rib extends in a direction corresponding to a direction in which the hook extends from the sub-housing.

8. The electronic apparatus of claim 1, wherein the elastic hole and the deformation portion extend along a longitudinal direction of the main housing.

9. The electronic apparatus of claim 8, wherein
the connection rib comprises a plurality of connection ribs provided along a direction in which the elastic hole extends, and
the plurality of connection ribs are spaced apart from each other to partition the elastic hole.

10. The electronic apparatus of claim 1, wherein the sub-housing is coupled to the main housing to cover the elastic hole.

11. The electronic apparatus of claim 2, wherein a width of the deformation portion is narrower than a width of the body portion.

12. The electronic apparatus of claim 1, wherein the sub-housing comprises a light-transmissive material.

13. The electronic apparatus of claim 1, wherein the electronic apparatus is a speaker apparatus.
